(19) United States
(12) Patent Application Publication
(10) Pub. No.: US 2025/0055860 A1
(43) Pub. Date: Feb. 13, 2025

(54) ATTACK DETECTION APPARATUS, ATTACK DETECTION METHOD, AND NON-TRANSITORY COMPUTER READABLE MEDIUM

(71) Applicant: Mitsubishi Electric Corporation, Tokyo (JP)

(72) Inventor: Koichi SHIMIZU, Tokyo (JP)

(73) Assignee: Mitsubishi Electric Corporation, Tokyo (JP)

(21) Appl. No.: 18/926,291

(22) Filed: Oct. 24, 2024

Related U.S. Application Data
(63) Continuation of application No. PCT/JP2022/020602, filed on May 18, 2022.

(51) Int. Cl. H04L 9/40

(52) U.S. Cl. CPC H04L 63/1416

(57) ABSTRACT

An attack detection apparatus (100) includes an attack detection unit (120), a pattern determination unit (130), and a final determination unit (140). The attack detection unit (120) executes for each of a plurality of pieces of communication data as subject data, an attack detection process to determine whether or not the subject data complies with one of rules included in an authorization list that includes a plurality of rules to each of which a unique identifier has been assigned. The pattern determination unit (130) execute a pattern determination process to determine whether or not an identifier corresponding to a rule with which the subject data complies conforms to an appearance pattern of identifiers derived from a model, using the model for determining whether the appearance pattern of the identifiers corresponding to rules each of which is complied with each of the plurality of pieces of communication data is normal or not. When the pattern determination process is executed, the final determination unit (140) determines whether the subject data is normal or not, using a determination result by the attack detection process and a determination result by the pattern determination process.

### CROSS REFERENCE TO RELATED APPLICATION

This application is a Continuation of PCT International Application No. PCT/JP2022/020602, filed on May 18, 2022, which is hereby expressly incorporated by reference into the present application.

### TECHNICAL FIELD

The present disclosure relates to an attack detection apparatus, an attack detection method, and an attack detection program.

### BACKGROUND ART

In recent years, the threat of cyber-attacks against industrial control systems has increased due to the opening up, networking, or the like of the industrial control systems. One of the countermeasures against a cyber-attack that enters through a network is an attack detection system that detects an attack activity by monitoring network communication. In particular, in the industrial control systems, attack detection methods that utilizes the fact that network communication is fixed include a method of creating an authorization list that includes a destination Internet Protocol (IP) address, a port number, or the like of a normal communication packet and detecting a communication packet that does not comply with the created authorization list as an attack, and a method of defining a characteristic of a further general normal communication packet and detecting a communication packet that deviates from the defined characteristic.

On the other hand, there is a cyber-attack that is performed by combining normal communication packets, and in the cyber-attack, the methods described above are bypassed and a cyber-attack is launched. Methods of detecting such a further advanced cyber-attack include a method of updating the authorization list depending on the state of a system, a method of making the authorization list to include a characteristic that spans a plurality of communication packets, such as an appearance order, an appearance frequency, or the like of the packets, a method of performing attack determination on a communication packet determined to be normal using the authorization list, using an additional another criterion, and the like.

Patent Literature 1 discloses a technique to determine communication in two stages. Here, in the first stage, attack detection using an authorization list is performed and communication that does not comply with a rule included in the authorization list is determined to be an attack. In the second stage, it is determined whether the communication is an attack or not according to the abnormality of the communication that complies with a rule included in the authorization list.

### CITATION LIST

### Patent Literature

Patent Literature 1: pamphlet of WO 2019/240020 A1

### SUMMARY OF INVENTION

### Technical Problem

According to the technology disclosed in Patent Literature 1, when one piece of communication data is to be determined using a feature corresponding to a plurality of elements relating to the one piece of communication data, the problem is that a processing load is relatively high due to the need to calculate the feature using the plurality of elements.

The present disclosure aims in a method of performing attack determination using an additional another criterion on a communication packet determined to be normal using an authorization list, not to calculate a feature using a plurality of elements when one piece of communication data is to be determined using the feature corresponding to the plurality of elements relating to the one piece of communication data.

### Solution to Problem

An attack detection apparatus according to the present disclosure includes:
an attack detection unit to execute for each of a plurality of pieces communication data as subject data, an attack detection process to determine whether or not the subject data complies with one of rules included in an authorization list that includes a plurality of rules to each of which a unique identifier has been assigned;
a pattern determination unit, when the subject data complies with one of the rules included in the authorization list, to execute a pattern determination process to determine whether or not an identifier corresponding to a rule with which the subject data complies conforms to an appearance pattern of identifiers derived from a model, using the model for determining whether the appearance pattern of the identifiers corresponding to rules each of which is complied with each of the plurality of pieces of communication data is normal or not; and
a final determination unit, when the pattern determination process is executed, to determine whether the subject data is normal or not, using a determination result by the attack detection process and a determination result by the pattern determination process.

### Advantageous Effects of Invention

According to the present disclosure, when subject data complies with one of rules included in an authorization list, an identifier corresponding a rule with which the subject data complies conforms to an appearance pattern of identifiers derived from a model. Here, the model is for determining whether the appearance pattern of the identifiers corresponding to rules each of which is complied with each of a plurality of pieces of communication data is normal or not. Accordingly, according to the present embodiment, in a method of performing attack determination using an additional another criterion on a communication packet determined to be normal using the authorization list, a feature is not calculated using a plurality of elements when one piece of communication data is to be determined using the feature corresponding to the plurality of elements relating to the one piece of communication data.

### BRIEF DESCRIPTION OF DRAWINGS

FIG. 1 is a diagram illustrating a functional configuration example of an attack detection apparatus 100 according to Embodiment 1.

FIG. 2 is a diagram for explaining a functional configuration example of an attack detection unit 120 according to Embodiment 1 where (a) is a diagram illustrating the functional configuration example of the attack detection unit 120 and (b) is a diagram illustrating a specific example of an authorization list 122.

FIG. 3 is a diagram illustrating a functional configuration example of a pattern determination unit 130 according to Embodiment 1.

FIG. 4 is a diagram for explaining a functional configuration example of a final determination unit 140 according to Embodiment 1 where (a) is a diagram illustrating the functional configuration example of the final determination unit 140 and (b) is a diagram illustrating a specific example of a determination integration unit 141.

FIG. 5 is a diagram for explaining a pattern of rule numbers according to Embodiment 1 where (a) is a diagram for explaining processing of the attack detection unit 120 and (b) is a diagram for explaining a rule number sequence.

FIG. 6 is a diagram for explaining a pattern of rule numbers according to Embodiment 1.

FIG. 7 is a diagram for explaining processing of a determination unit 133 according to Embodiment 1.

FIG. 8 is a diagram illustrating a hardware configuration example of the attack detection apparatus 100 according to Embodiment 1.

FIG. 9 is a flowchart illustrating operation of the attack detection apparatus 100 according to Embodiment 1.

FIG. 10 is a diagram illustrating a hardware configuration example of the attack detection apparatus 100 according to a modification of Embodiment 1.

FIG. 11 is a diagram illustrating a functional configuration example of the pattern determination unit 130 according to Embodiment 2.

FIG. 12 is a diagram illustrating a specific example of pattern classification information 136 according to Embodiment 2.

FIG. 13 is a diagram for explaining pattern classifications according to Embodiment 2.

FIG. 14 is a diagram for explaining processing of a collation unit 121 according to Embodiment 3.

FIG. 15 is a diagram for explaining processing of the collation unit 121 according to Embodiment 3.

FIG. 16 is a diagram for explaining processing of the collation unit 121 according to Embodiment 3.

FIG. 17 is a diagram for explaining communication data 202 according to Embodiment 3.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in the drawings mainly indicate flows of data or flows of processing. Further, “unit” may be suitably interpreted as “circuit”, “step”, “procedure”, “process”, or “circuitry”.

### Embodiment 1

The present embodiment will be described in detail below with reference to the drawings.

### *** Description of Configuration ***

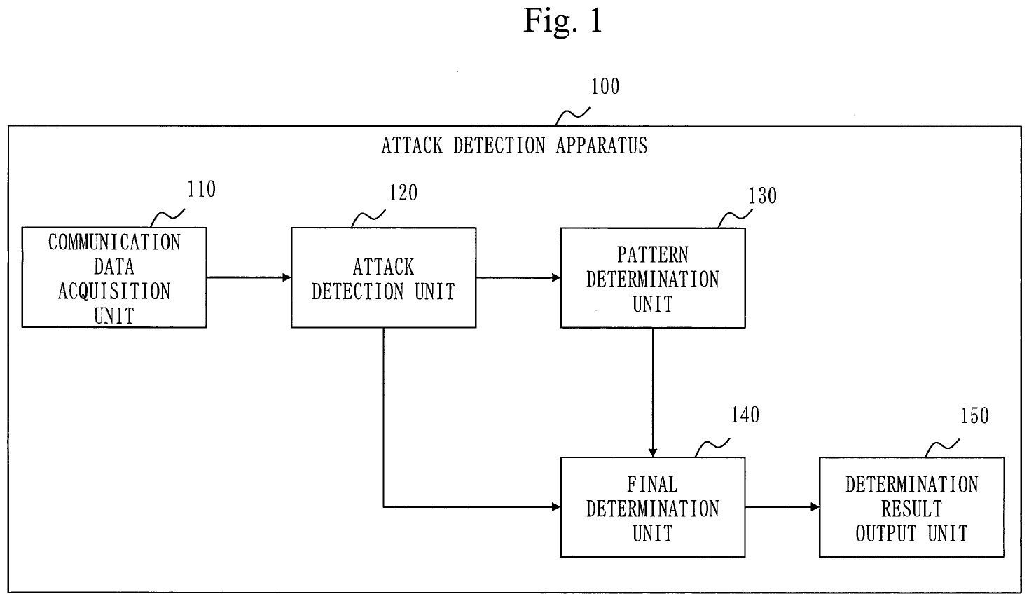

FIG. 1 is a block diagram illustrating a functional configuration example of an attack detection apparatus 100. The attack detection apparatus 100 includes a communication data acquisition unit 110, an attack detection unit 120, a pattern determination unit 130, a final determination unit 140, and a determination result output unit 150, as illustrated in FIG. 1. The attack detection unit 120 is also referred to as an authorization list type attack detection unit. The pattern determination unit 130 is also referred to as a rule number pattern determination unit.

The communication data acquisition unit 110 acquires communication data 202.

The communication data 202 is communication data to be detected and is communication data to be input into the attack detection unit 120.

The attack detection unit 120 determines whether or not the communication data 202 is data authorized by an authorization list 122. The attack detection unit 120 executes for each of a plurality of pieces of communication data 202 as subject data, an attack detection process to determine whether or not the subject data complies with one of rules included in the authorization list 122.

The authorization list 122 is a white list in which a characteristic of communication to be authorized is defined as a rule, and is data indicating an identifier of each rule and a list enumerating the characteristic of communication authorized by each rule. A specific example of the identifier of the rule is a rule number. The authorization list 122 usually includes a plurality of rules. A unique identifier has been assigned to each rule.

The pattern determination unit 130 determines communication data 202 determined to be data authorized by the authorization list 122, based on a rule number 206 corresponding to the communication data 202. When the subject data complies with one of the rules included in the authorization list 122, the pattern determination unit 130 executes a pattern determination process to determine using a model relating to an appearance pattern of an identifier, whether or not an identifier corresponding to a rule with which the subject data complies conforms to the appearance pattern of the identifier derived from the model. The model is for determining whether or not the appearance pattern of the identifier corresponding to the rule with which each of the plurality of pieces of communication data 202 complies is normal or not. When the identifier corresponding to the subject data conforms to the appearance pattern of the identifier derived from the model, an identifier to be estimated from the appearance pattern as the identifier corresponding to the subject data is consistent with an identifier corresponding to the actual subject data, or a characteristic indicated in the appearance pattern is not inconsistent with a characteristic indicated in an appearance pattern of an identifier corresponding to each of all pieces of communication data 202 that have been received at a time when the subject data is received, as a specific example. The pattern determination unit 130 may learn the model relating to the appearance pattern of the identifier, using the plurality of pieces of communication data 202 determined to be normal and the appearance pattern of the identifier corresponding to each of the plurality of pieces of communication data 202 determined to be normal.

The rule number 206 is an identifier for each rule, and is used to check which rule included in the authorization list 122 the communication data 202 complies with when the communication data 202 is determined to be authorized communication.

The final determination unit 140 decides a final determination result by integrating a determination result 205 and a determination result 303. When the pattern determination process is executed, the final determination unit 140 determines whether the subject data is normal or not, using a determination result through the attack detection process and a determination result through the pattern determination process. When the subject data is normal, the subject data is not data relating to an attack, as a specific example. When the subject data has been determined in the attack detection process not to comply with any of the rules included in the authorization list 122, the final determination unit 140 determines that the subject data is not normal. When the subject data has been determined in the attack detection process to comply with one of the rules included in the authorization list 122, the final determination unit 140 determines that the subject data is normal in a case where the identifier corresponding to the rule with which the subject data complies has been determined not to be consistent with the appearance pattern derived from the model in the pattern determination process.

The determination result 205 is data that indicates a result of determination by the attack detection unit 120, and is data that represents whether the communication data 202 is authorized communication or not.

The determination result 303 is data that indicates a result of determination by the pattern determination unit 130.

The determination result output unit 150 outputs the final determination result.

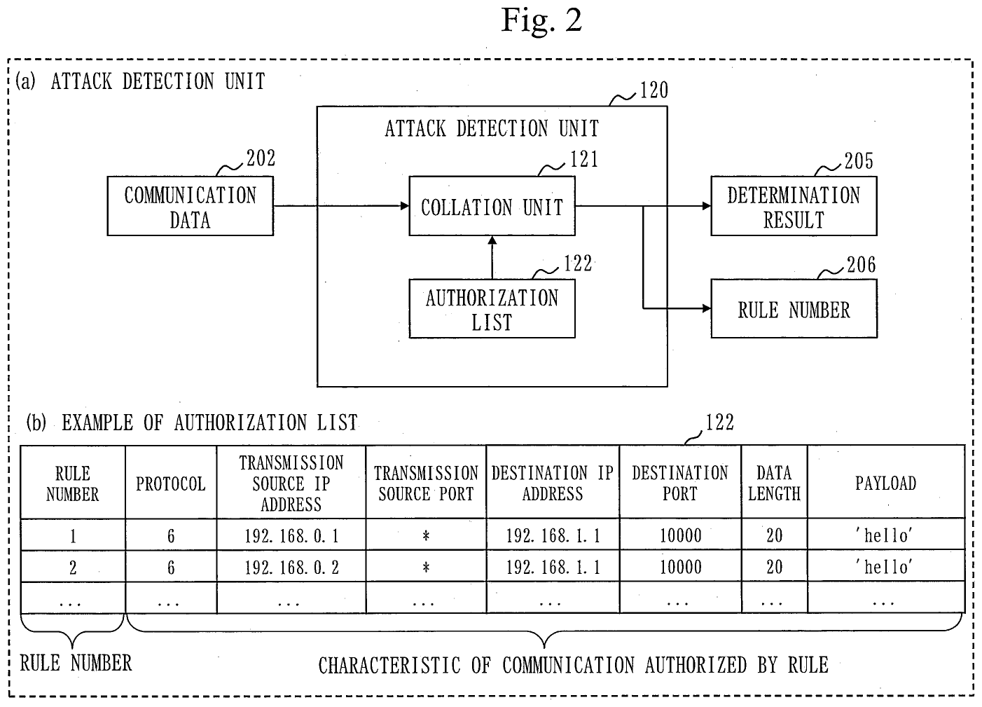

(a) of FIG. 2 is a block diagram illustrating a functional configuration example of the attack detection unit 120. The attack detection unit 120 includes a collation unit 121 and the authorization list 122, as illustrated in (2) of FIG. 2.

The collation unit 121 determines whether communication according to the communication data 202 is authorized communication or not, by collating the communication data 202 with the authorization list 122. The collation unit 121 outputs the determination result 205 and the rule number 206.

(b) of FIG. 2 illustrates a specific example of the authorization list 122.

As illustrated in the present example, in the authorization list 122 according to the present embodiment, a rule number which is an identifier is assigned to each rule without duplication, and it is assumed that there is a one-to-one correspondence between the rule number and the rule. Further, it is assumed that the identifier is represented by an integer or a value that has a one-to-one correspondence with an integer. That is, it is assumed that the identifier can be treated as an integer in a computer.

On the other hand, a characteristic of communication is usually expressed in a format that combines a plurality of items whose types differ from each other, for the purpose of achieving relatively high accuracy in attack detection. In the present example, the characteristic of the communication consists of 7 items: a protocol; a transmission source Internet Protocol (IP) address; a transmission source port; a destination IP address; a destination port; a data length; and a payload. In such a manner, in the authorization list 122 according to the present embodiment, one identifier is assigned to one characteristic of communication which consists of a plurality of items. In terms of processing efficiency in a computer, it is obvious that it is more efficient to process one identifier than to process one characteristic of communication that is made up of a plurality of items whose types differ from each other, as a combination.

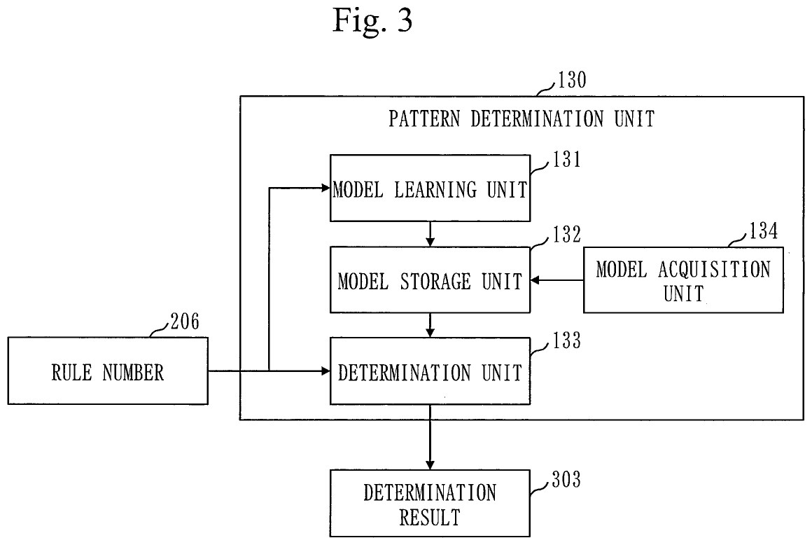

FIG. 3 is a block diagram illustrating a functional configuration example of the pattern determination unit 130. The pattern determination unit 130 includes a model learning unit 131, a model storage unit 132, a determination unit 133, and a model acquisition unit 134, as illustrated in FIG. 3.

The determination unit 133 determines whether the rule number 206 is normal or not, and outputs a determined result as the determination result 303. In determining whether the rule number 206 is normal or not, the determination unit 133 collates the rule number with a rule number model. The rule number model is a modeled appearance pattern of a normal rule number.

The model learning unit 131 learns the rule number model, using a rule 302 corresponding to the normal communication data 202 as input.

The model acquisition unit 134 acquires the rule number model by external input.

The model storage unit 132 stores the rule number model learned by the model learning unit 131 or the rule number model externally acquired by the model acquisition unit 134.

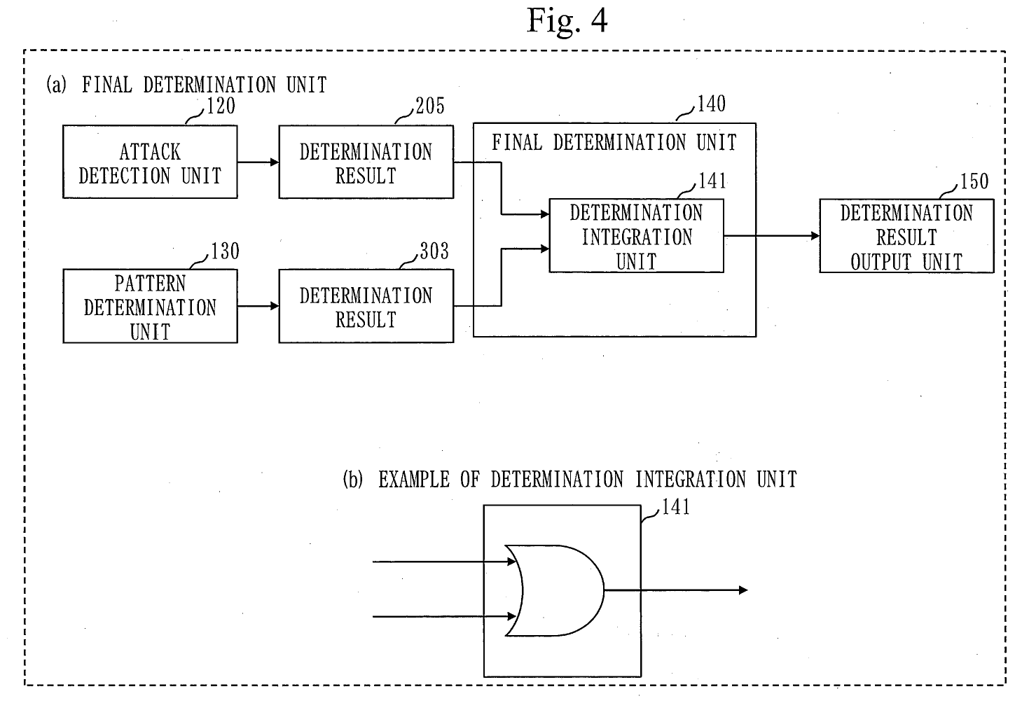

(a) of FIG. 4 is a block diagram illustrating a functional configuration example of the final determination unit 140. The final determination unit 140 includes a determination integration unit 141 as illustrated in FIG. 4.

In the present embodiment, two types of determination results which are the determination result 205 by the attack detection unit 120 and the determination result 303 by the pattern determination unit 130 are obtained for the communication data 202. The determination integration unit 141 decides a final determination result by integrating these two types of determination results, and outputs the decided determination result.

(b) of FIG. 4 illustrates a specific example of processing of the determination integration unit 141. The determination integration unit 141 adopts a method of calculating the logical sum of two pieces of input, as an integration method of the determination results, as a specific example. That is, when certain communication data 202 has been determined to be an attack by at least one of the attack detection unit 120 and the pattern determination unit 130, the certain communication data 202 is finally determined to be an attack. Thus, if certain communication data 202 has been determined to be an attack by the attack detection unit 120, the certain communication data 202 is determined to be an attack by the final determination unit 140. Further, even if certain communication data 202 has been determined to be normal by the attack detection unit 120, the certain communication data 202 is determined to be an attack by the final determination unit 140 if the certain communication data 202 has been determined to be an attack by the pattern determination unit 130. Determining that the communication data 202 is an attack includes determining that communication corresponding to the communication data 202 is an attack.

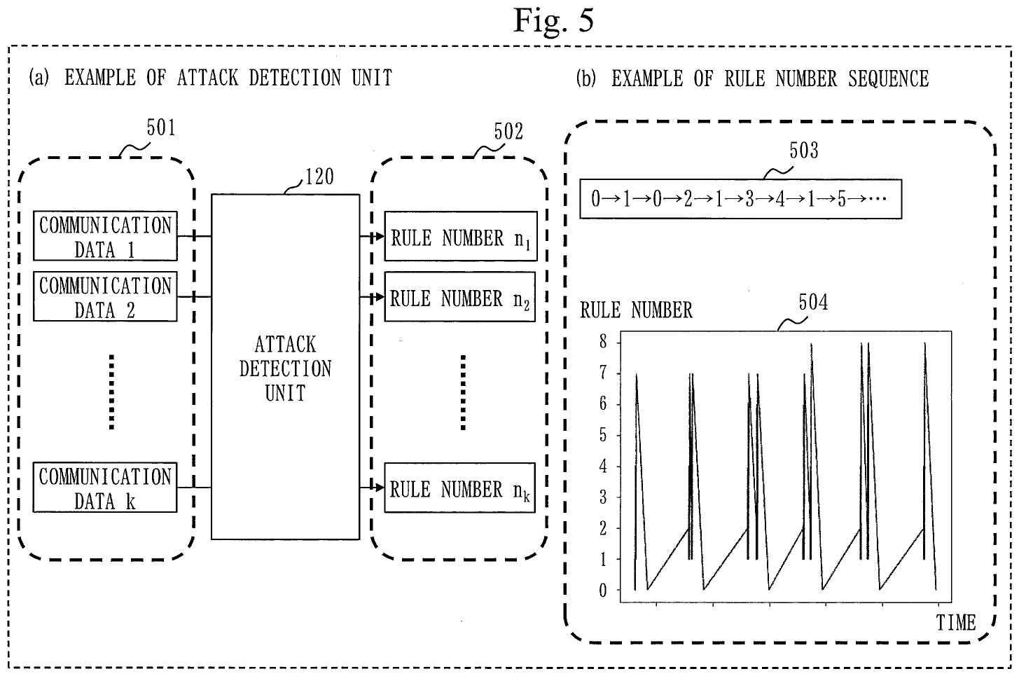

A pattern of rule numbers will be described with reference to FIG. 5. When normal packets are input one after another to the attack detection unit 120, rule numbers each of which corresponds to each packet are output one after another from the attack detection unit 120. The rule number corresponding to each packet is a rule number indicating a rule with which each packet complies.

(a) of FIG. 5 represents a state in which, when a packet sequence 501 is input, a rule number sequence 502 that consists of rule numbers each of which corresponds to each packet of the input packet sequence 501 is output from the attack detection unit 120. Here, the packet sequence 501 is assumed to consist of normal packets.

(b) of FIG. 5 illustrates a specific example of a numerical sequence 503. The numerical sequence 503 is an example of the rule number sequence 502 corresponding to the normal packet sequence 501. (b) of FIG. 5 represents a state in which, when normal packets are input to the attack detection unit 120 in the order of reception of the normal packets, the rule number corresponding to each of the input packets is output in the order of 0, 1, 0, 2, 1, 3, 4, 1, 5, . . . . Further, a graph 504 is a graph in which each element of the rule number sequence 502 is plotted with the time on the horizontal axis and the rule number on the vertical axis. The horizontal axis indicates the time at which a packet corresponding to each element of the rule number sequence 502 is received. Here, the regularity of the rule number sequence 502 appears as a geometric pattern in the graph 504. In such a manner, in the present embodiment, by assigning a rule number to each rule included in the authorization list 122, and associating each rule with each number, the regularity of rules corresponding to normal packets is obvious as the regularity of rule numbers.

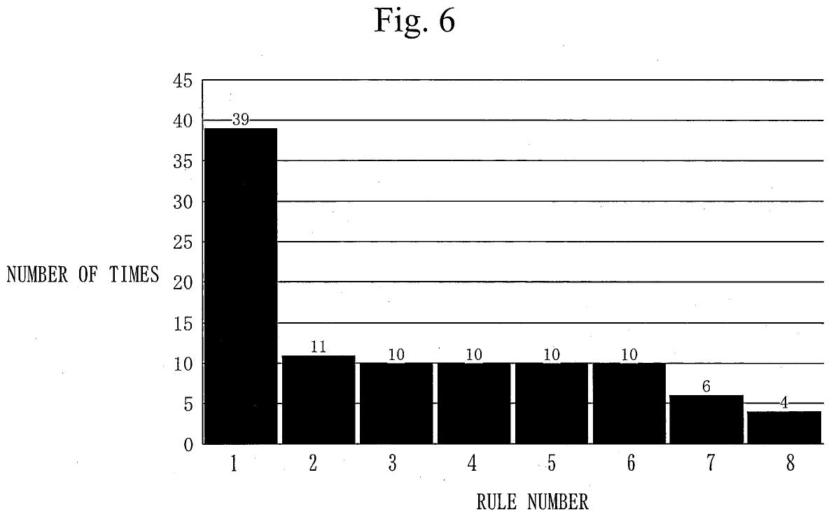

FIG. 6 illustrates another specific example of a pattern of rule numbers. FIG. 6 is a histogram that represents the number of pieces of communication data 202 each of which corresponds to each rule number of the authorization list 122 at a time when a total of 100 pieces of normal communication data 202 is given. From this histogram, it can be seen that the majority (about 40 percent) of the normal communication data 202 corresponds to the rule number 1, the small portion (about 4 percent) of the normal communication data 202 corresponds to the rule number 8, and the like.

The model learning unit 131 learns a pattern of rule numbers such as above. A technique used by the model learning unit 131 for learning is arbitrary. However, it is known that a technique called Long Short Term Memory (LSTM) is suitable for time series data such as the graph 504, as a specific example. Further, a histogram as illustrated in FIG. 6 can be generated by counting the number of pieces of communication data 202 each of which corresponds to each rule number.

Then, as described above, calculating a feature of a rule number expressed by one integer is more efficient in computer processing than calculating a feature of communication that consists of a plurality of items whose types differ from each other. Therefore, a learning cost can be reduced by learning a pattern of rule numbers.

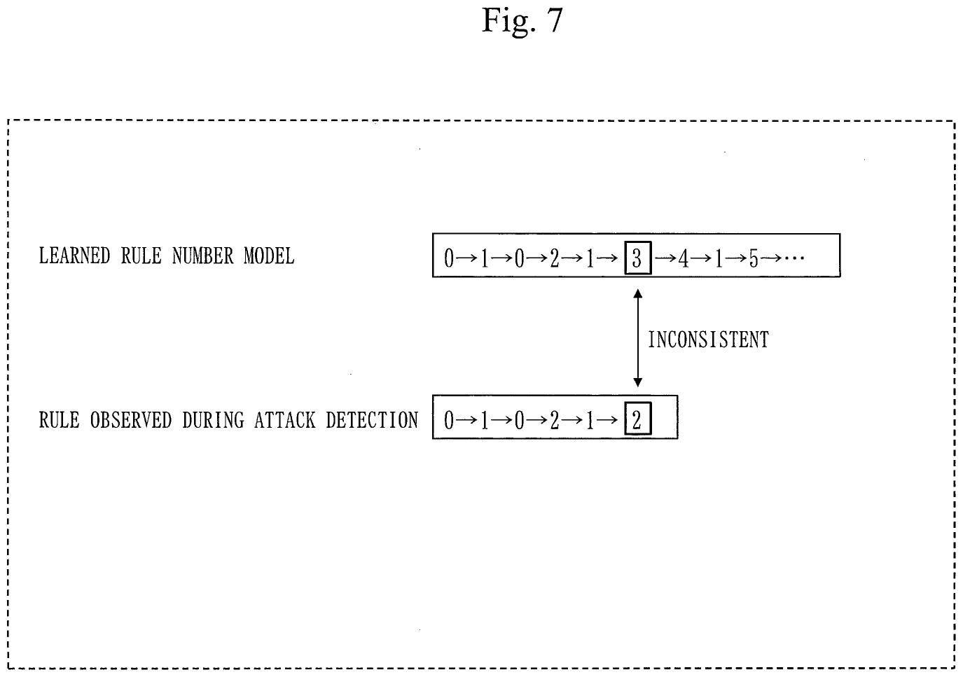

FIG. 7 illustrates an operational example of the determination unit 133. Here, it is assumed that 0, 1, 0, 2, 1, 3, 4, 1, 5, . . . as the order of rule numbers corresponding to normal communication data 202 is learned as a rule number model. The determination unit 133 predicts a rule number to be corresponded to normal communication data 202 to be received next, using the rule number model, and determines whether the rule number corresponding to the communication data 202 actually received during attack detection is correct or not, based on the predicted rule number.

Here, it is assumed that the rule numbers corresponding to the communication data 202 received during the attack detection are 0, 1, 0, 2, 1, 2 in the order in which the communication data 202 has been received. At this time, “2” which is the rule number corresponding to communication data 202 received last is not “3” which is the rule number to be corresponded to the communication data 202. Therefore, the determination unit 133 determines that the communication data 202 is an attack. In the present example, it is determined to be an attack when the rule numbers are not exactly consistent. However, it does not need to be determined to be an attack even if the rule numbers are not exactly consistent. The rule number model may be a model indicating a statistical property or a probabilistic property of a pattern of rule numbers, and the determination unit 133 may determine to be an attack when the statistical property or the probabilistic property indicated in the model is inconsistent with the pattern of the rule numbers, as a specific example.

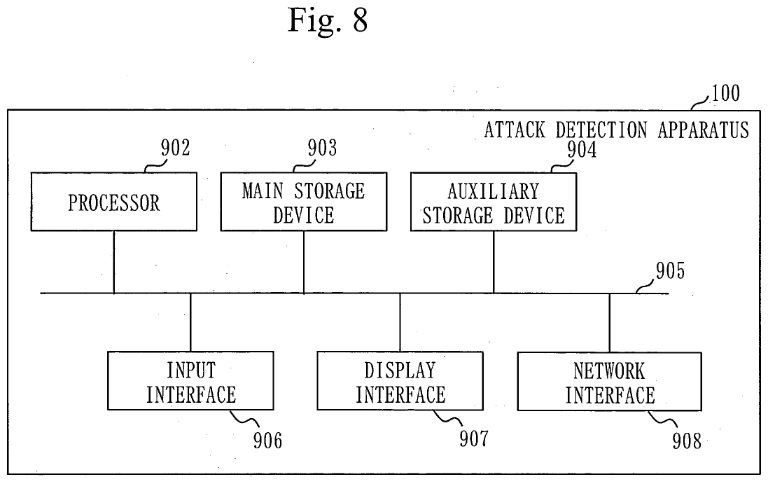

FIG. 8 illustrates a hardware configuration example of the attack detection apparatus 100, and an example of a computer that implements the attack detection apparatus 100. The present example illustrates a configuration in which a processor 902, a main storage device 903, an auxiliary storage device 904, an input interface 906, a display interface 907, and a network interface 908 are connected to a data bus 905, as seen in a general computer. The attack detection apparatus 100 may consist of a plurality of computers.

The processor 902 is an Integrated Circuit (IC) that performs arithmetic processing, and controls hardware included in the computer. A specific example of the processor 902 is a Central Processing Unit (CPU), a Digital Signal Processor (DSP), or a Graphics Processing Unit (GPU).

A plurality of processors may be included as an alternative to the processor 902. The plurality of processors shares the role of the processor 902.

The main storage device 903 is typically a volatile memory device, and is, as a specific example, a Random Access Memory (RAM). The main storage device 903 is also referred to as a main memory. Data stored in the main storage device 903 is saved in the auxiliary storage device 904 as necessary.

The auxiliary storage device 904 is typically a non-volatile storage device, and is, as a specific example, a Read Only Memory (ROM), a Hard Disk Drive (HDD), or a flash memory. Data stored in the auxiliary storage device 904 is loaded into the main storage device 903 as necessary.

The input interface 906 is a port to which an input device is connected, and is, as a specific example, a Universal Serial Bus (USB) terminal. Specific examples of the input device are a keyboard and a mouse.

The display interface 907 is a port to which a display device is connected, and is, as a specific example, a High-Definition Multimedia Interface (HDMI, registered trademark) terminal. A specific example of the display device is a display.

The network interface 908 is a receiver and a transmitter. A specific example of the network interface 908 is a communication chip or a Network Interface Card (NIC).

Processing of the attack detection unit 120, the pattern determination unit 130, and the like is implemented as the attack detection program which is a software program, and the attack detection program is usually held in the auxiliary storage device 904. The attack detection program is read by the processor 902 into the faster main storage device 903, and executed.

The attack detection program may be recorded on a computer readable non-volatile recording medium. A specific example of the non-volatile recording medium is an optical disc or a flash memory. The attack detection program may be provided as a program product.

Data used when the attack detection program is executed, data and the like obtained by executing the attack detection program are stored in a storage device as appropriate. Each unit of the attack detection apparatus 100 uses the storage device as appropriate. The storage device consists of at least one of the main storage device 903, the auxiliary storage device 904, a register in the processor 902, and a cache memory in the processor 902, as a specific example. Data and information may have the same meaning. The storage device may be independent of the computer.

When attack detection is performed in real time, the communication data 202 to be acquired by the communication data acquisition unit 110 is acquired from the network interface 908. On the other hand, when the attack detection is performed on the communication data 202 that has been acquired in the past, it is also conceivable to acquire the communication data 202 held in the auxiliary storage device 904. A result of the attack detection may be virtually displayed by the display interface 907 or may be notified to a remote operator via the network interface 908. Further, the input interface 906 may be used for the purpose of a setting of the attack detection apparatus 100 or the like. Editing the authorization list 122 and the rule number model, or the like is conceivable as a specific example of the setting of the attack detection apparatus 100.

When the attack detection apparatus 100 is implemented in a form such as a router as a specific example, the attack detection apparatus 100 may not have the input interface 906, the display interface 907, and the like. Further, it is also conceivable that a part or all of the attack detection process may be implemented as hardware rather than software. In this case, it is conceivable that the attack detection apparatus 100 is an apparatus that includes a logic circuit such as a Field Programmable Gate Array (FPGA).

### *** Description of Operation ***

An operational procedure of the attack detection apparatus 100 is equivalent to an attack detection method. Further, a program that implements operation of the attack detection apparatus 100 is equivalent to an attack detection program.

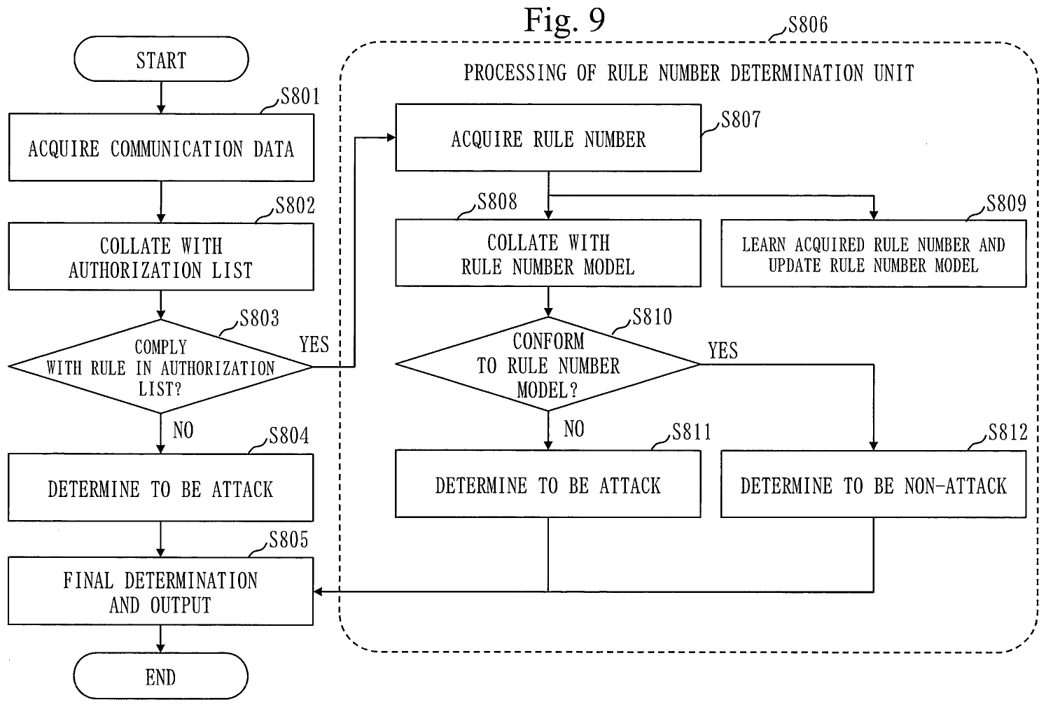

FIG. 9 is a flowchart illustrating an example of the overall operation of the attack detection apparatus 100. The operation of the attack detection apparatus 100 will be described with reference to FIG. 9.

### (Step S801)

The communication data acquisition unit 110 acquires the communication data 202 subject to attack detection.

### (Step S802)

The collation unit 121 collates the acquired communication data 202 with the authorization list 122.

### (Step S803)

When the acquired communication data 202 complies with one of the rules included in the authorization list 122, the attack detection apparatus 100 proceeds to step S806. In other cases, the attack detection apparatus 100 proceeds to step S804.

### (Step S804)

The collation unit 121 determines that the acquired communication data 202 is an attack.

### (Step S805)

The determination integration unit 141 performs final determination by integrating the determination result by the collation unit 121 and the determination result by the determination unit 133. When there is no determination result by the determination unit 133, the determination integration unit 141 performs the final determination without using the determination result by the determination unit 133.

The determination integration unit 141 outputs data indicating a result of performing the final determination.

### (Step S806)

Step S806 consists of steps S807 to S812. After the process of step S806 is completed by the determination unit 133, the attack detection apparatus 100 proceeds to step S805.

### (Step S807)

The determination unit 133 acquires the rule number corresponding to the acquired communication data 202.

### (Step S808)

The determination unit 133 reads the rule number model from the model storage unit 132, and determines whether or not the acquired rule number conforms to the read rule number model.

### (Step S809)

The model learning unit 131 updates the rule number model by learning the rule number acquired in step S807 in parallel with the process of step S808.

### (Step S810)

In step S808, when the acquired rule number has been determined not to conform to the read rule number model, the determination unit 133 proceeds to S811. In other cases, the determination unit 133 proceeds to step S812.

### (Step S811)

The determination unit 133 determines that the acquired communication data 202 is an attack.

### (Step S812)

The determination unit 133 determines that the acquired communication data 202 is not an attack.

### Description of Effects of Embodiment 1

As described above, according to the present embodiment, by assigning a unique identifier to each of rules included in the authorization list 122, a feature of the communication data 202 which is usually represented by a plurality of items whose types differ from each other, is represented by a single identifier, and the represented identifier is subject to learning. Therefore, a cost of learning a sequence or a statistical characteristic of normal communication, and the like can be reduced.

Further, according to the present embodiment, in authorization list type attack detection, a process of extracting the feature to be learned is implemented by a process of acquiring an identifier corresponding to a rule with which the communication data 202 complies. Therefore, according to the present embodiment, a cost of extracting the feature necessary for learning can be reduced.

Accordingly, according to the present embodiment, attack detection with relatively high accuracy can be realized with a relatively small amount of calculational resources, in attack detection that combines authorization list type attack detection and attack detection by learning.

### Other Configurations

### Modification 1

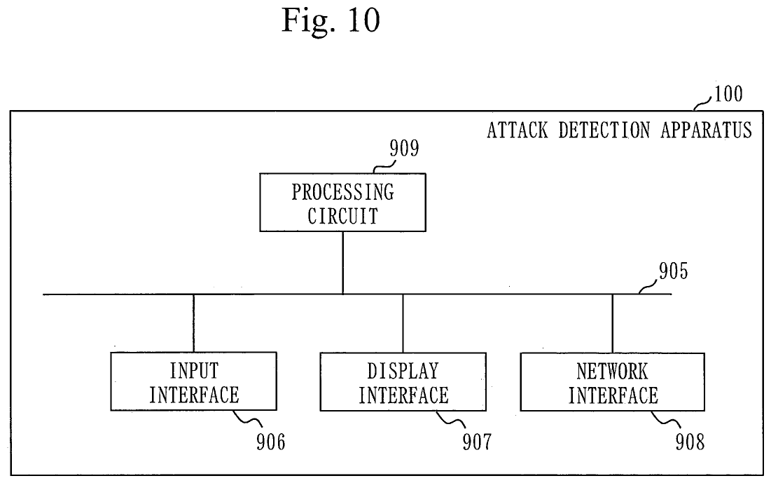

FIG. 10 illustrates a hardware configuration example of the attack detection apparatus 100 according to the present modification.

The attack detection apparatus 100 includes a processing circuit 909 in place of the processor 902, the processor 902 and the main storage device 903, the processor 902 and the auxiliary storage device 904, or the processor 902, the main storage device 903, and the auxiliary storage device 904.

The processing circuit 909 is hardware that implements at least a part of each unit included in the attack detection apparatus 100.

The processing circuit 909 may be dedicated hardware, or may be a processor that executes a program stored in the main storage device 903.

When the processing circuit 909 is the dedicated hardware, a specific example of the processing circuit 909 is a single circuit, a composite circuit, a programmed processor, a parallel programmed processor, an Application Specific Integrated Circuit (ASIC), a Field Programmable Gate Array (FPGA), or a combination thereof.

The attack detection apparatus 100 may include a plurality of processing circuits as an alternative to the processing circuit 909. The plurality of processing circuits share the rile of the processing circuit 909.

In the attack detection apparatus 100, some functions may be implemented by the dedicated hardware, and the remaining functions may be implemented by software or firmware.

The processing circuit 909 is implemented by, as a specific example, hardware, software, firmware, or a combination of thereof.

The processor 902, the main storage device 903, the auxiliary storage device 904, and the processing circuit 909 are collectively referred to as “processing circuitry”. That is, the functions of the individual functional components of the attack detection apparatus 100 are implemented by the processing circuitry.

The attack detection apparatus 100 according to other embodiments may also have the same configuration as that of the present modification.

### Embodiment 2

In the following, differences from the embodiment described above will be mainly described with references with the drawings.

### *** Description of Configuration ***

In Embodiment 1, by learning a pattern of identifiers corresponding to the normal communication data 202, a pattern of the normal communication data 202 is learned relatively efficiently. However, according to Embodiment 1, it is not obvious how to select an appropriate learning technique at a time when each of various possible patterns of the normal communication data 202 is given. Here, when information relating to a specification of a subject system is available, the meaning of each rule, a possible pattern of an identifier, and the like can be known in advance from the information. Therefore, in this case, it is possible to select a learning technique suitable for each pattern of rule numbers, to generate a rule number model directly without using a learning technique, or the like. The present embodiment aims to use the information relating the specification of the subject system.

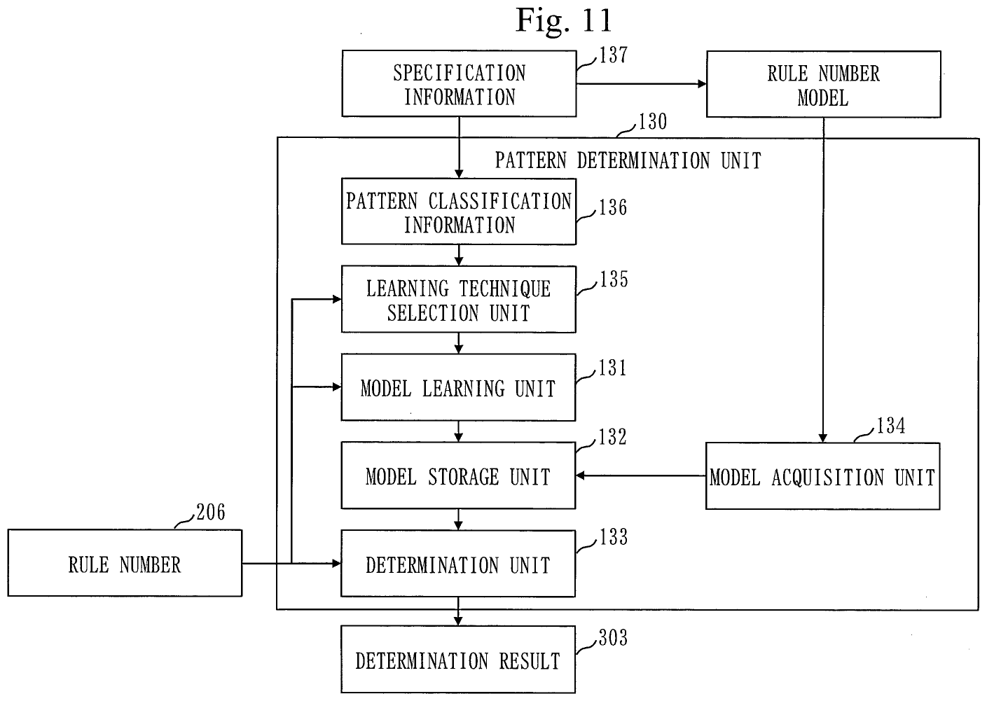

FIG. 11 is a block diagram illustrating a functional configuration example of the pattern determination unit 130 according to the present embodiment. The pattern determination unit 130 further includes a learning technique selection unit 135 and pattern classification information 136, as illustrated in FIG. 11. The pattern determination unit 130 selects a method of learning a model relating to an appearance pattern of identifiers, depending on a classification of the appearance pattern of the identifiers corresponding to each of the plurality of pieces of the communication data 202 determined to be normal.

The pattern classification information 136 is information to be generated based on specification information 137, and is information indicating the pattern classification.

The specification information 137 is information that can be obtained in advance, and is information indicating the specification or the like of the subject system.

The learning technique selection unit 135 selects a learning technique suitable for a pattern of rule numbers, using the pattern classification information 136.

The model learning unit 131 learning a rule number model, using the learning technique selected by the learning technique selection unit 135.

The rule number model can be created in advance based on the specification information 137. When the rule number model has been created in advance, the model acquisition unit 134 may acquire the created rule number model.

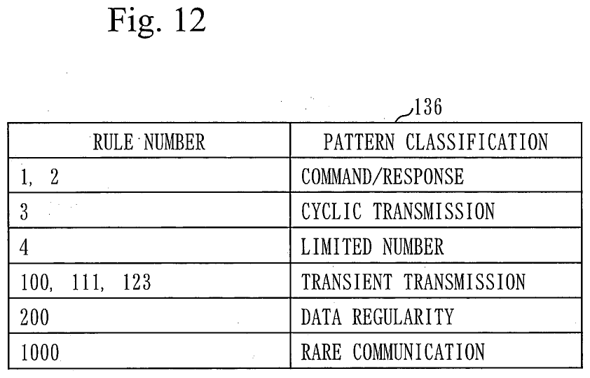

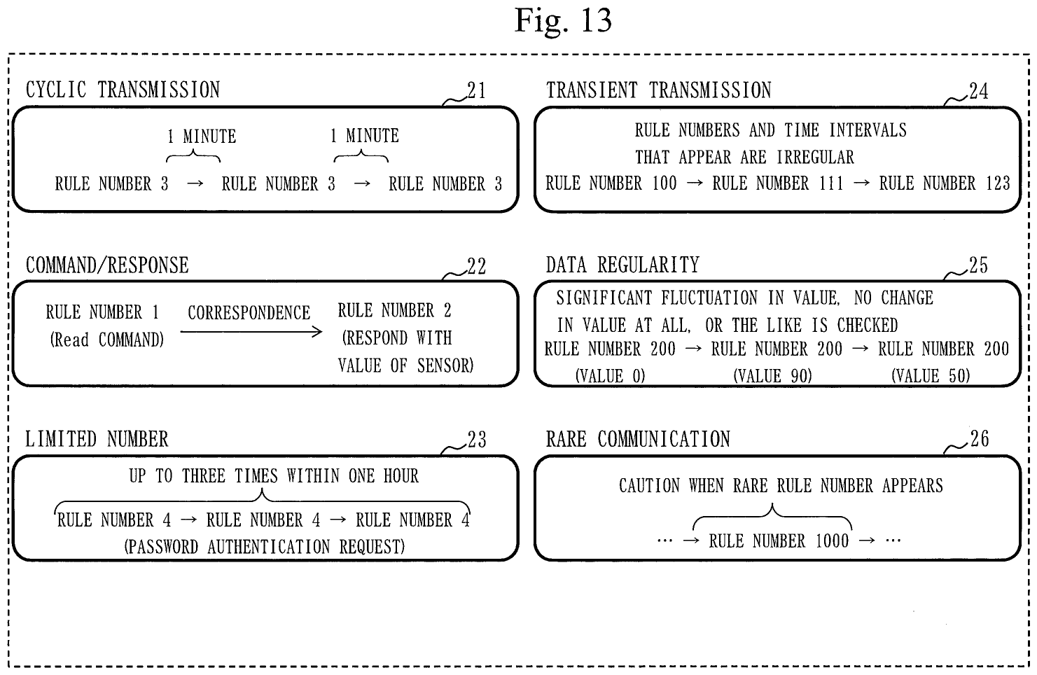

FIG. 12 illustrates a specific example of the pattern classification information 136. The meaning of each of pattern classifications will be described with reference to FIG. 13.

FIG. 13 illustrates specific examples of the pattern classifications. FIG. 13 illustrates each pattern with cyclic transmission 21, a command/response 22, a limited number 23, transient transmission 24, data regularity 25, and rare communication 26, as a specific example of the pattern classification. Further, FIG. 13 illustrates a specific example of each pattern.

In a control system, a distinction is sometimes made between two types of communication by referring to communication that occurs periodically as cyclic transmission and communication that occurs arbitrarily as transient transmission, as a specific example.

The cyclic transmission 21 illustrates that the communication data 202 corresponding to a rule number 3 appears at one-minute intervals. A learning technique suitable for periodic data or time-series data is selected for such a pattern of communication, as a specific example. Here, the pattern illustrated in the graph 504 of FIG. 5 can also be considered as cyclic transmission. A plurality of rule numbers as a whole illustrate a periodic pattern in the graph 504. Therefore, when using the graph 504 as learning data, the model learning unit 131 may learn a pattern for the whole of the plurality of rule numbers. On the other hand, in this case, the model learning unit 131 may learn the individual rule numbers separately by treating them as a superposition of a plurality of rule numbers each of which has periodicity.

Unlike the cyclic transmission, the rule numbers and time intervals that appear are usually irregular in the transient transmission, as illustrated in the transient transmission 24. Therefore, when the communication is the transient transmission, there is a high possibility that the same learning technique as a learning technique used when the communication is the cyclic transmission is not suitable.

In the transient transmission 24, the communication data 202 is assumed to be generated by manual operation, and it is conceivable to learn a state in which appearance intervals of rule numbers are not constant and the appearance intervals vary widely, as a specific example.

The command/response 22 represents a pattern of rule numbers corresponding to command/response type communication. In the command/response type communication, when a Read command is transmitted from a control apparatus to a device, a value of a sensor is transmitted from the device to the control apparatus, as a response to the Read command, as a specific example.

The command/response 22 represents a simple command/response in which the communication data 202 corresponding to a rule number 1 and the communication data 202 corresponding to a rule number 2 make one round trip.

More generally, when the communication data 202 appears as a communication protocol according to a predetermined rule, a technique of learning the rule as a state transition diagram may be selected. Further, a case where the communication protocol is defined in advance as the state transition diagram is also conceivable as the specification information 137. In this case, the model acquisition unit 134 may acquire the defined state transition diagram.

The limited number 23 represents a pattern in which there is a limit on the number of times that communication corresponding to a rule number 4 is authorized in a certain period. Operation in which communication of a password authentication request is only authorized up to three times within one hour, that is, operation in which the password authentication is not executed for a certain period of time if the password authentication fails three times within one hour, is implemented in the limited number 23. Although such a limited number relating to the password authentication needs to be originally implemented as an authentication system, the limited number is illustrated here as a specific example.

The data regularity 25 represents communication in which a rule number 200 transmits temperature data. The data regularity 25 represents that a temperature indicated in the temperature data fluctuates significantly from 0 to 90 to 50. Here, the significant fluctuation in the temperature acquired by the same sensor in a short period of time is not normal behavior. Therefore, when a value indicated in the communication data 202 fluctuates significantly, the determination unit 133 can determine that the communication data 202 is an attack. In such a case, the learning technique selection unit 135 can select a technique of leaning a model relating to a system being monitored and controlled using the communication data 202, as a specific example, a model relating to a temperature change. In the data regularity 25, when a value relating to communication does not change unnaturally at all, the communication may be determined to be an attack.

The rare communication 26 represents communication in which communication data 202 corresponding to a rule number 1000 is rarely received. Learning of a statistical model as illustrated in FIG. 6 is conceivable for such communication. This may be used to determine the correctness of an appearance frequency of a rule number that appears rarely, and to determine rare communication data 202 as an attack in order to urge caution against receiving the rare communication data 202 even if the rare communication data 202 corresponds to normal communication.

Although each pattern has been described as being independent, a combination of several patterns is also possible. While certain communication is based on the pattern of the command/response, it is sufficiently conceivable that regularity appears in the communication data 202 to be exchanged in the certain communication, as a specific example.

The pattern classifications described above are only examples. In such a manner, there are various patterns possible for normal communication data 202 in a subject system. A model with high accuracy can be learned when the communication data 202 that complies with the various patterns is learned by different techniques each of which is suitable for each pattern, rather than the communication data 202 being learned collectively by a single learning technique. A case where two pieces of learning data are generated without mixing two types of communication data 202 is more reasonable than a case where learning data is generated by mixing communication data 202 of the cyclic transmission and communication data 202 of the transient transmission, which have completely different characteristics, as a specific example. A point of the present embodiment is to generate the pattern classification information 136 in advance based on the specification information 137 for the purpose of learning a model with higher accuracy, and to be able to select an appropriate learning technique for each rule number based on the generated pattern classification information 136.

### Description of Effects of Embodiment 2

As described above, when the specification information 137 of a subject system is available in advance, the pattern classification information 136 can be generated by classifying in advance communication patterns that may occur in the subject system. Thus, the learning technique selection unit 135 that selects a learning technique using the pattern classification information 136 is provided in the present embodiment. This makes it possible to select the appropriate learning technique depending on a communication pattern corresponding to packets. Therefore, accuracy of attack detection through learning can be increased.

Further, according to the present embodiment, learning techniques can be separated for each pattern of packets. Therefore, in implementation of a computer, it is easy to execute processing relatively efficiently, by assigning a process corresponding to each pattern to a separate thread, a CPU, or the like.

### Embodiment 3

In the following, differences from the embodiments described above will be mainly described with reference to the drawings.

### *** Description of Configuration ***

In Embodiments 1 and 2, it is assumed that rules each of which defines a characteristic of the communication data 202 that is considered to be normal are listed sequentially and that a unique identifier is assigned to each rule, as a data structure of the authorization list 122. However, there is no particular order in which the rules are listed. Therefore, a method of checking the rules sequentially from the top of the rules is conceivable as a method of searching for a rule corresponding to the communication data 202 to be detected. Since the processing time in this method increases in proportion to the number of rules. this method is not suitable in such a case where the number of rules included in the authorization list 122 is large. Thus, it is conceivable to use a hash table, as the data structure and a search method of the authorization list 122 that is not affected by the number of rules. In the present embodiment, the hash table is used in the authorization list 122.

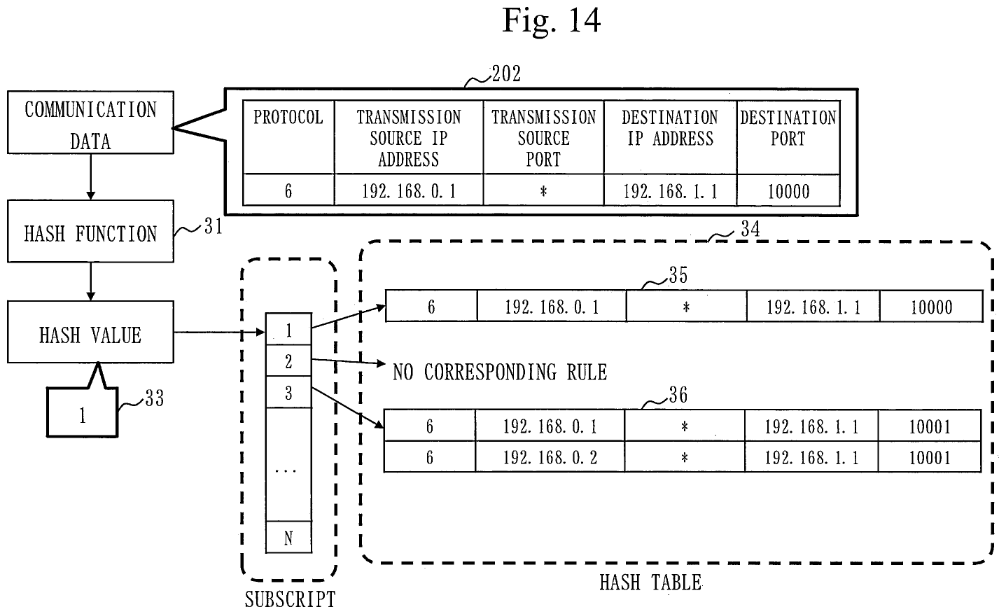

FIG. 14 is a diagram for explaining an example of a collation method of the authorization list 122, using the hash table.

When the attack detection unit 120 according to the present embodiment collates subject data with each rule included in the authorization list 122, the attack detection unit 120 collates a hash value corresponding to the subject data with a value corresponding to each rule included in the authorization list 122.

A hash function 31 is designed to output a value equal to or greater than 1 and less than or equal to N (N is a positive integer) by calculation on an input value, and is also designed to perform the calculation at high speed.

Further, a hash table 34 is designed to be accessible, using a subscript equal to or greater than 1 and less than or equal to N. In particular, at a position accessed using a hash value 33 corresponding to authorized communication data 202, as the subscript, a rule corresponding to the communication data 202 is stored.

In FIG. 14, when communication data 202 is given, 1 is calculated as the hash value 33 by the hash function 31, and the subscript to be accessed is found to be 1. Here, a rule 35 is stored in the hash table 34, as a rule corresponding to a subscript 1. Therefore, the communication data 202 is found to be communication authorized by the authorization list 122.

On the other hand, when the hash value 33 corresponding to communication data 202 is 2, there is no data corresponding to a subscript 2 in the hash table 34. Therefore, in this case, the communication data 202 is found to be unauthorized communication. On the premise that the calculation of the hash function 31 is performed at high speed, a collation process using the hash table 34 can be performed at high speed.

However, in search for data using the hash table 34, it is necessary to consider the possibility that the hash values 33 are consistent with each other for inputs that differ from each other. Here, in the hash table 34 illustrated in FIG. 14, there are two pieces of rules 36 which are rules corresponding to a subscript 3. This means that the hash values 33 corresponding to the communication data 202 corresponding to each of these two pieces of the rules 36 are consistent with each other.

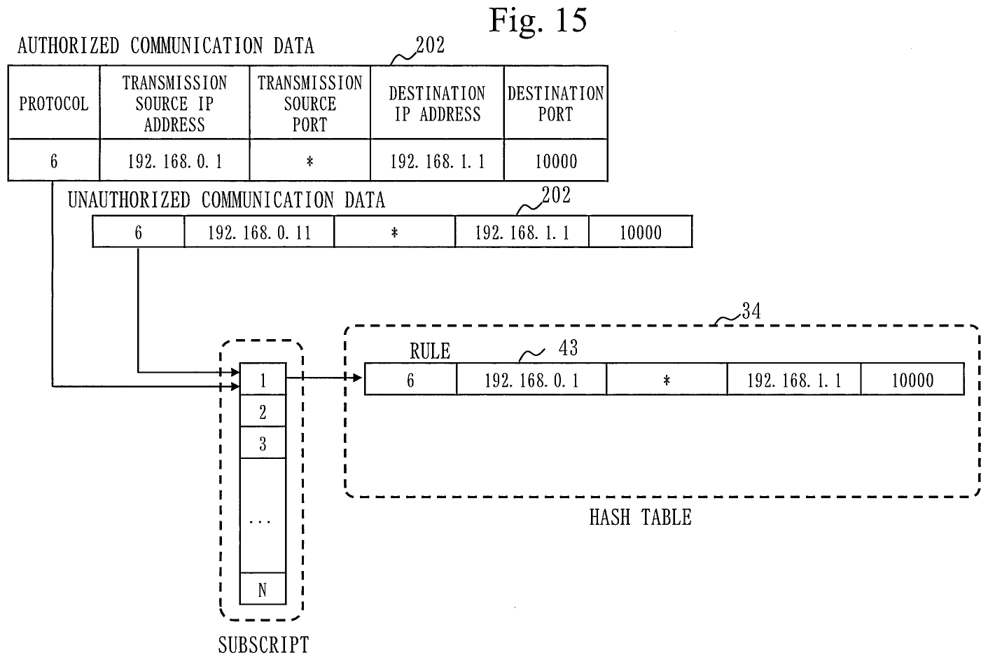

Further, FIG. 15 illustrates another specific example where the hash values 33 for inputs that differ from each other are consistent with each other. In the present example, both of the hash value 33 of the authorized communication data 202 and the hash value 33 of the unauthorized communication data 202 are 1, and are consistent with each other. Here, although the unauthorized communication data 202 needs to be determined to be an attack, simply checking for the presence of a rule corresponding to the subscript 1 in the hash table 34 results in the communication data 202 being erroneously determined to be authorized communication.

Accordingly, when communication data 202 collates with the authorization list 122, it is necessary to first check to see if there is a rule in the hash table 34 with the hash value 33 corresponding to the communication data 202, as the subscript, and then to check to see if the checked rule actually corresponds to the communication data 202. As a result, by collating a rule 43 corresponding to the subscript 1 with the unauthorized communication data 202, and checking that they do not conform with each other, the collation unit 121 can finally determine that the communication data 202 is an attack, for example.

In the hash table 34 described above, since a subscript used to access each rule is not unique, the subscript cannot be learned as a rule number. Thus, data stored in the hash table 34 includes unique rule numbers in addition to rules.

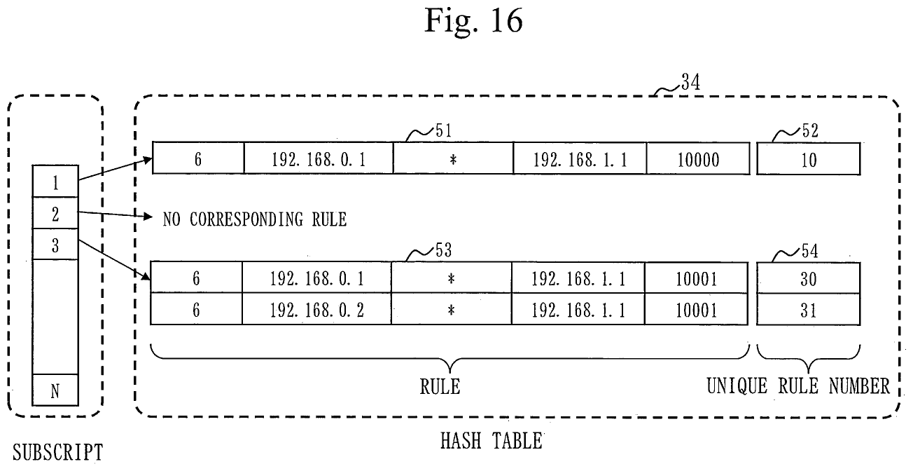

In the hash table 34 illustrated in FIG. 16, a rule 51 and a rule number 52 corresponding to the rule 51 are stored for the subscript 1, as a specific example. Further, a rule 53 and a rule number 54 corresponding to the rule 53 are stored for the subscript 3. There are two pieces of rules each of which corresponds to the subscript 3, and a unique rule number is assigned to each rule. Although a decision method of a rule number varies, an integer with a subscript K in the tens digit and used to access the hash table 34 is assigned as a rule number, in the example illustrated in FIG. 16. As a result, if there are 10 or less rules whose corresponding subscripts conform with each other, a unique rule number can be assigned to each rule.

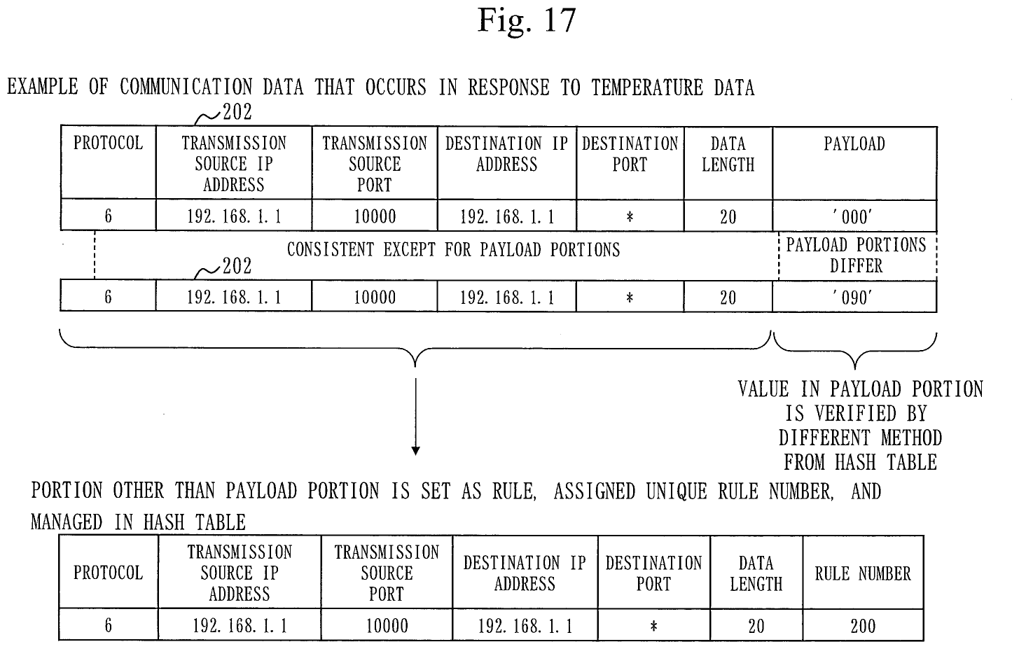

FIG. 17 illustrates a specific example of packets generated in response to temperature data. In the present example, the temperature data is represented in the payload portion. When application data or the like is represented in the payload portion as in the present example, the payload portion changes depending on the application data or the like. However, the communication data 202 except for the payload portion is often unchanged. When a rule that authorizes such communication data 202 is stored in the hash table 34, the efficiency is reduced because the data in the hash table 34 is huge if the rule is prepared for each possible value of the communication data 202. Thus, when the payload portion represents the application data or the like, and the communication data 202 that does not change except for the payload portion is handled, the portion other than the payload portion is set as a rule. a unique rule number is assigned to each rule, and the hash table 34 manages each rule to which the unique rule number has been assigned. Further, the validity of a value in the payload portion is verified by a different method from the method using the hash table 34. The different method is the same as the method illustrated in the data regularity 25 of FIG. 13.

### Description of Effects of Embodiment 3

As described above, according to the present embodiment, even when the hash table 34 is used as a data structure and a search method of the authorization list 122, a unique rule number is assigned to each rule. Further, according to the present embodiment, a rule on a portion other than a payload portion is generated for such communication data 202 in which application data or the like is represented in the payload portion. Therefore, the same learning as the learning described in Embodiments 1 and 2 can be applied to the present embodiment.

### Other Embodiments

Each of the above described embodiments can be freely combined, or any component of each of the embodiments can be modified. Alternatively, any component can be omitted in each of the embodiments.

Alternatively, the embodiments are not limited to those presented in Embodiments 1 to 3, and various modifications can be made as needed. The procedures described using the flowcharts or the like may be suitably modified.

### REFERENCE SIGNS LIST

100: attack detection apparatus; 110: communication data acquisition unit; 120: attack detection unit; 121: collation unit; 122: authorization list; 130: pattern determination unit; 131: model learning unit; 132: model storage unit; 133: determination unit; 134: model acquisition unit; 135: learning technique selection unit; 136: pattern classification information; 137: specification information; 140: final determination unit; 141: determination integration unit; 150: determination result output unit; 21: cyclic transmission; 22: command/response; 23: limited number; 24: transient transmission; 25: data regularity; 26: rare communication; 202: communication data; 205: determination result; 206: rule number; 31: hash function; 33: hash value; 34: hash table; 35, 36, 43: rule; 302: rule; 303: determination result; 51, 53: rule; 52, 54: rule number; 501: packet sequence; 502: rule number sequence; 503: numerical sequence; 504: graph; 902: processor; 903: main storage device; 904: auxiliary storage device; 905: data bus; 906: input interface; 907: display interface; 908: network interface; 909: processing circuit.

1. An attack detection apparatus comprising:
processing circuitry:
to execute for each of a plurality of pieces communication data as subject data, an attack detection process to determine whether or not the subject data complies with one of rules included in an authorization list that includes a plurality of rules to each of which a unique identifier has been assigned;
when the subject data complies with one of the rules included in the authorization list, to execute a pattern determination process to determine whether or not an identifier corresponding to a rule with which the subject data complies conforms to an appearance pattern of identifiers derived from a model, using the model for determining whether the appearance pattern of the identifiers corresponding to rules each of which is complied with each of the plurality of pieces of communication data is normal or not; and
when the pattern determination process is executed, to determine whether the subject data is normal or not, using a determination result by the attack detection process and a determination result by the pattern determination process.

2. The attack detection apparatus according to claim 1, wherein
when the subject data has been determined in the attack detection process not to comply with any of the rules included in the authorization list, the processing circuitry determines that the subject data is not normal, and
when the identifier corresponding to the rule with which the subject data complies has been determined in the pattern determination process not to conform to the appearance pattern derived from the model at a time when the subject data has been determined in the attack detection process to comply with one of the rules included in the authorization list, the processing circuitry determines that the subject data is not normal.

3. The attack detection apparatus according to claim 1, wherein
the processing circuitry learns the model, using a plurality of pieces of communication data determined to be normal and an appearance pattern of identifiers each of which corresponds to each of the plurality of pieces of communication data determined to be normal.

4. The attack detection apparatus according to claim 2, wherein
the processing circuitry learns the model, using a plurality of pieces of communication data determined to be normal and an appearance pattern of identifiers each of which corresponds to each of the plurality of pieces of communication data determined to be normal.

5. The attack detection apparatus according to claim 3, wherein
the processing circuitry to select a method of learning the model depending on classification of the appearance pattern of the identifiers each of which corresponds to each of the plurality of pieces of communication data determined to be normal.

6. The attack detection apparatus according to claim 4, wherein
the processing circuitry to select a method of learning the model depending on classification of the appearance pattern of the identifiers each of which corresponds to each of the plurality of pieces of communication data determined to be normal.

7. The attack detection apparatus according to claim 1, wherein
when the processing circuitry collates the subject data with each rule included in the authorization list, the processing circuitry collates a hash value corresponding to the subject data with a value corresponding to each rule included in the authorization list.

8. The attack detection apparatus according to claim 2, wherein
when the processing circuitry collates the subject data with each rule included in the authorization list, the processing circuitry collates a hash value corresponding to the subject data with a value corresponding to each rule included in the authorization list.

9. The attack detection apparatus according to claim 3, wherein
when the processing circuitry collates the subject data with each rule included in the authorization list, the processing circuitry collates a hash value corresponding to the subject data with a value corresponding to each rule included in the authorization list.

10. The attack detection apparatus according to claim 4, wherein
when the processing circuitry collates the subject data with each rule included in the authorization list, the processing circuitry collates a hash value corresponding to the subject data with a value corresponding to each rule included in the authorization list.

11. The attack detection apparatus according to claim 5, wherein
when the processing circuitry collates the subject data with each rule included in the authorization list, the processing circuitry collates a hash value corresponding to the subject data with a value corresponding to each rule included in the authorization list.

12. The attack detection apparatus according to claim 6, wherein
when the processing circuitry collates the subject data with each rule included in the authorization list, the processing circuitry collates a hash value corresponding to the subject data with a value corresponding to each rule included in the authorization list.

13. An attack detection method comprising:
executing for each of a plurality of pieces communication data as subject data, an attack detection process to determine whether or not the subject data complies with one of rules included in an authorization list that includes a plurality of rules to each of which a unique identifier has been assigned;
when the subject data complies with one of the rules included in the authorization list, executing a pattern determination process to determine whether or not an identifier corresponding to a rule with which the subject data complies conforms to an appearance pattern of identifiers derived from a model, using the model for determining whether the appearance pattern of the identifiers corresponding to rules each of which is complied with each of the plurality of pieces of communication data is normal or not; and
when the pattern determination process is executed, determining whether the subject data is normal or not, using a determination result by the attack detection process and a determination result by the pattern determination process.

14. A non-transitory computer readable medium storing an attack detection program for causing an attack detection apparatus which is a computer to execute:
for each of a plurality of pieces communication data as subject data, an attack detection process to determine whether or not the subject data complies with one of rules included in an authorization list that includes a plurality of rules to each of which a unique identifier has been assigned;
when the subject data complies with one of the rules included in the authorization list, a pattern determination process to determine whether or not an identifier corresponding to a rule with which the subject data complies conforms to an appearance pattern of identifiers derived from a model, using the model for determining whether the appearance pattern of the identifiers corresponding to rules each of which is complied with each of the plurality of pieces of communication data is normal or not; and
a final determination process, when the pattern determination process is executed, to determine whether the subject data is normal or not, using a determination result by the attack detection process and a determination result by the pattern determination process.
